(19) United States
(12) Patent Application Publication
(10) Pub. No.: US 2003/0179735 A1
(43) Pub. Date: Sep. 25, 2003

(54) System and method of portable data management

(76) Inventors: Ramachandran Suresh, Silver Spring, MD (US); George Schwenke, Silver Spring, MD (US)

Correspondence Address: Clifford Kraft, 320 Robin Hill Dr., Naperville, IL, 60540, US

(21) Appl. No.: 10/274,720

(22) Filed: Oct. 18, 2002

Related U.S. Application Data
(60) Provisional application No. 60/367,666, filed on Mar. 23, 2002.

(51) Int. Cl. H04Q 7/24

(52) U.S. Cl. 370/338

(57) ABSTRACT

A system and method of managing the collection of remote field data where processors such as PDAs are placed at remote locations. The processors are coupled to a location determination means such as a GPS receiver and also to a wireless interface such as a wireless internet access means such as a LAN or cellular telephone. The remote data can be transferred over the wireless access to a central station which can be an internet server. The data can finally be transferred to a central database which can be located on a website.

This application is related to and claims priority from U.S. Provisional patent application 60/367,666. U.S. Provisional application 60/367,666 is hereby incorporated by reference.

### BACKGROUND

1. Field of the Invention

The present invention relates generally to the field of remote data gathering and more particularly to a system and method of portable data management.

2. Description of Related Art

In capturing weather data and many other remote data gathering operations, it is not uncommon for geographically diverse observers to report observation data to a common site or to multiple collection sites. Observation locations at schools, homes, businesses, and other places can report local meteorological conditions several times a day. Usually these conditions are written or otherwise noted and then reported to a collection site. There is a great chance of error at the central site when numerous reports come in from many locations. An especially common occurrence is an error in the location of the reporting station.

Recently networks called “mesonet” or “meso-scale meteorological networks” have become popular. Their systems are based on small sensor suites located at schools, homes and other places. The number of these observer sites is increasing rapidly. Such sites are less comprehensive than larger-scale observation stations like those of the NWS or FAA because the instrument suites are simpler. Yet, the specification and collection of quality observed weather data from these stations will enable their data to be used to augment existing surface observations. The number of these stations is expected to grow and rapidly exceed the number of established NWS/FAA stations. Their wide geographic dispersal will provide an excellent source of supplementary data for weather analysis, warnings, and numerical prediction models.

Currently data are manually written down, reported, and then subsequently retransmitted from field offices, such as weather stations, all around the globe. The location of the observation is normally entered or transmitted separately. Having a very large number of field stations causes this practice to be prone to frequent errors. It also takes significant time to manage the data thus making real-time evaluation is almost difficult.

Another area of current interest is the case where some high schools and other schools are issuing ID cards with bar codes. The intent is to use these cards to positively identify students and to help keep track of where students are in relation to where they should be. At present, there is no way to directly enter data on a student directly into a central location for determination of status (for example, a student found outside of class during school hours: is the student cutting classes?). Also, it has not been possible to positively document where the student was at the time he or she was intercepted.

Numerous other remote field operations require a human to enter data into some type of personal data gathering device like a PDA for later transfer.

What is needed is a data management system that can allow human or automatic entry of data that will then couple that data with the exact geographic location of the observer. This data can then be fed into one or more collection sites.

### SUMMARY OF THE INVENTION

The present invention relates to a portable data management system and method (PDMS) that can contain a plurality of portable devices such as Palm, Pocket PC, or other PDA devices (including any type of portable processor) each coupled with a location determining means such as a GPS receiver and a wireless internet access means. The GPS or location receiver can be totally integrated with the processor to automatically give longitude and latitude of the observer at the time the observation is made. The units can be contained in the same housing or separate housings. Wireless transfer of data can be made immediately or at a later time, and the wireless transfer can be my means of a wireless internet access, or by any other wireless method or means.

The present invention relates to a PDA/Wireless web-based application suite for remote data or metadata (weather station information meteorological data) collection, manipulation and transmission or for remote reporting of any type of data including for use in schools to report locations of students, etc. A single station can contain a position location receiver unit such as a GPS receiver, a Palm/PocketPC unit or similar personal data device or portable computer or processor, and specialized algorithms to collect, manage, and transit remote station data to one or more centralized databases. These databases can be web-based. It should be understood that the system could equally well employ a microprocessor or microcontroller module or any other processor instead of a personal data unit. In addition, any type of location reporting method or means can be used with GPS being preferred. However, Loran, VOR, and any other position determining method is within the scope of the present invention.

It is preferred to use open standards and interfaces; however, the invention will work with any standard or interface, open or not. Also, while a web-based communication and data system is preferred, any communication and data system of method can be used including private systems, intranet systems and the internet. In particular, the data transfer does not have to be by wireless methods in that any data communication or transfer method will work. These methods can include communication by wire, cable, fiber optics and any other communication means. In particular cellular telephone is convenient to access the internet.

### DESCRIPTION OF THE DRAWINGS

FIG. 1 shows an overview block diagram of an embodiment of the system.

FIG. 2 shows the architecture of a plurality of remote reporting locations in an embodiment of the system.

FIG. 3 shows a detailed diagram of a remote arrangement.

It should be noted that the drawings illustrate and explain the present invention. It will be appreciated by one skilled in the art that many other embodiments and designs are within the scope of the present invention.

### DETAILED DESCRIPTION

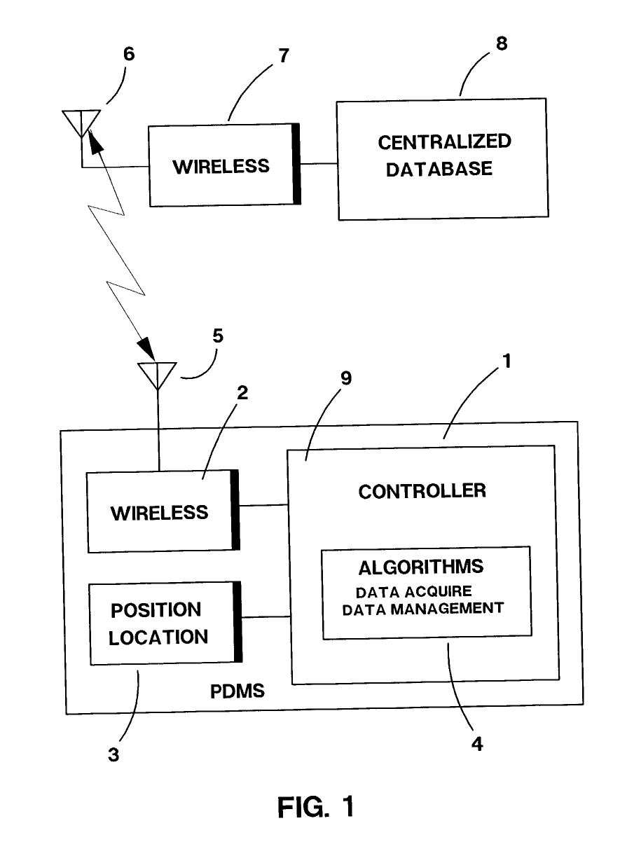

Turning to FIG. 1 a block diagram of an embodiment of the present invention can be seen. Here a position location receiver 3 can provide continuous location information to a PDA or other personal data unit or controller 9. The PDA can contain specialized programming or algorithms 4 to acquire data entered by a user or observer. This programming can cause the data to be stored temporarily in the PDA (immediate transmission is also possible). Data management routines allow entry, retrieval, editing, local manipulation and consistency checking of the entered and stored data. The preferred method is the use of a database table structure similar to XML; however, any database or data manipulation methods are within the scope of the present invention.

The controller or PDA unit 9 along with the position locator or GPS receiver 3 and a wireless interface 2 and other optional equipment can make up a PDMS or remote unit 1. The wireless interface 2 couples to an antenna 5 that provides a wireless link to a base station or other fixed or mobile station 7 that also contains at least one antenna 6. This wireless access station 7 can provide direct or remote access to a central database 8. One embodiment of the present invention uses the cellular telephone system to provide online access to the internet. In this embodiment, the centralized database 8 can be located on a website. However, the wireless interface 2, 5, 6, 7 is not limited to cellular telephone, but can be any wireless network such as a wireless LAN, WAN, Bluetooth, an IEEE 802.11 network or any other wireless communication means.

Data transmission programming allows the PDA or controller 9 to transfer data by any possible means into the internet or directly to a centralized database. As can be seen in FIG. 1, larger databases can exist on a central web server at one or more central locations or independently of the internet.

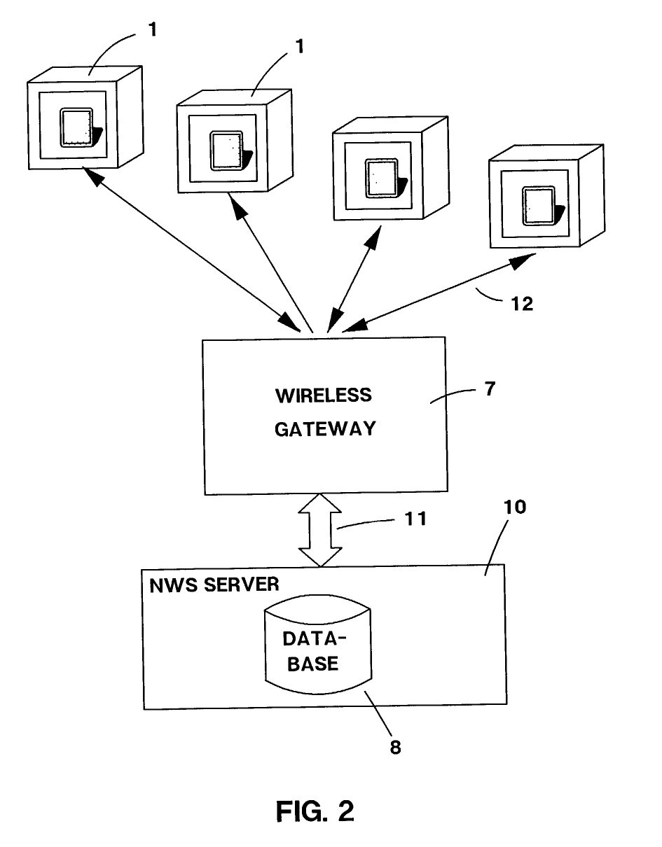

FIG. 2 shows a plurality of remote station 1 such as those diagrammed in FIG. 1. Each of these remote stations 1 can be a PDA or other controller or computer with an integrated or separate GPS receiver or other position location means for real-time position input. Each PDA or remote station can contain data manipulation algorithms as described above. Each PDA or remote station can be equipped with wireless web access or other wireless access 12. One or more central stations can be tied into a wireless gateway 7 with a central database 8 located on a server 10 or other computer or system of computers. It should be noted that the database in FIG. 2 can be distributed between multiple locations and need not reside on a single server or computer.

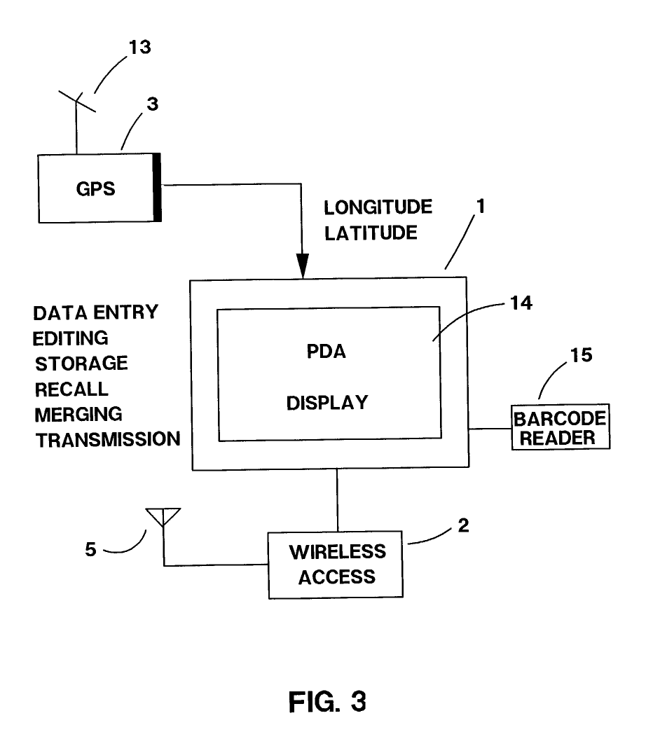

FIG. 3 shows a detailed diagram of a possible embodiment of a remote unit. A GPS receiver 3 with a satellite receiving antenna 13 can continuously make location data of longitude and latitude available to a PDA or other controller 1. The GPS receiver 1 can be equipped with an internal receiving antenna or an external antenna 13 which receives GPS satellite data or any other type of location data from any type of navigation or location system. The PDA or controller 1 can contain a display screen 14 which can be used to display data both as it is being entered or after it is entered. The entry can be a table data type structure where various fields are filled in or any other means of entering or storing data.

The PDA or controller 1 can be coupled to a wireless interface 2 that can transmit data by wireless form via a radio antenna 5. The preferred method is wireless internet access of any type; however as has been stated, any wireless or wire or other communications method is within the scope of the present invention. The wireless interface 2 can contain a radio antenna 5 which normally operates in the UHF or Microwave radio bands; however any frequency range or band is within the scope of the invention.

It can be appreciated that the present invention is applicable to many different types of data gathering applications. Among these are inventory status and tracking, instrument calibration data, and numerous other field data reporting applications, both in private industry and by federal, state and local government entities. The present invention is particularly useful for mesoscale systems such as the State of Maryland's “Roadway Weather Information System” or RWIS. In the case of weather observations, the existence of many small reporting stations contribute significantly to the density of surface observations used in numerical analysis and modeling of weather data. However, this is only possible if appropriate quality control can be exercised over the data. Information such as sensor type, exposure, calibration and availability is essential for the most beneficial use of the data. The present invention is particularly adapted to this type of application.

An alternate embodiment of the present invention can be used in schools or other institutions. This embodiment can incorporate a bar code reader or wand into the integrated system described 15. This device can read a student ID card or any ID card and enter its data instantly into the system. The location receiver can provide real-time position data as to where the event occurred. Thus the exact location of the student at the time the data entry is made becomes part of the permanent database record of the event. After the data is transferred to a central node, say at the school office, all significant information about this student can be immediately reported to an administrator (for example, the student was reported absent last class period and is thus “skipping classes”). In this manner, the actions of the administrator can be based on real-time, current information which cannot be altered and becomes part of the permanent record. It will be apparent that this type of system can equally well be used by law enforcement, fire departments, municipalities, hospitals and numerous other types of entities or agencies that require data to be acquired in the field where the exact position and time the data was taken is important. It is within the scope of the present invention to provide a portable unit that can collect field data, couple that data with exact geographic location, and time stamp exactly where and when the data were taken. The data can then be immediately (or with delay) transmitted to a centralized database for storage and processing via any type of wireless interface.

While the preferred embodiments of the present invention have been shown and described, it is to be understood that various modifications and changes could be made thereto without departing from the scope of the invention. One skilled in the art would clearly understand that the means shown to accomplish the invention are for illustration only, and that many other means and methods are within the scope of the present invention.

We claim:

1. A system for gathering remote data from a plurality of locations, the system comprising:
a plurality of remote reporting locations, each reporting data to a central location;
at least one processor located at each of said remote reporting locations;
said processor containing algorithms for data acquisition and data transmission, said processor acquiring data;
said processor coupled to a position reporting system, said position reporting system providing said processor with real-time location information;
said processor coupled to a wireless interface, said wireless interface able to transmit said data and said real-time location information to said central station.

2. The system of claim 1 wherein said position reporting system is a GPS receiver.

3. The system of claim 1 wherein said processor is a PDA.

4. The system of claim 1 where in said data is meteorological data.

5. The system of claim 1 further comprising a bar-code reader.

6. The system of claim 6 wherein said bar-code reader identifies student ID cards.

7. The system of claim 6 wherein said data is information from said student ID card.

8. A web-based remote data acquisition system for gathering data from remote sites comprising:
a processor device located at each of said remote sites, said processor device containing a key entry means and a memory, remote data being entered by said key entry means for storage in said memory;
a GPS receiver coupled to said processor device, said GPS receiver supplying position information to said processor device;
a wireless internet interface coupled to said processor, whereby said processor can access the internet;
a wireless server in communication with said processor device, said processor device transferring said remote data and said position information on command or automatically;
a remote database located on a website, said remote database receiving and storing said remote data from said processor via said wireless internet interface and said wireless server.

9. The web-based remote data acquisition system of claim 8 wherein said processor is a PDA.

10. The web-based remote data acquisition system of claim 8 wherein said processor is a laptop computer.

11. The web-based remote data acquisition system of claim 8 wherein said wireless interface is a cellular telephone transceiver.

12. The web-based remote data acquisition system of claim 8 wherein said wireless interface is a wireless LAN.

13. A method of gathering remote data comprising the steps of:
placing a plurality of remote stations at locations where remote field data is desired;
coupling each of said remote stations to a location determining means for determining a location of that particular remote station;
coupling each of said remote stations to a wireless interface;
allowing each of said remote stations to transfer remote field data and said location information via said wireless interface to a central database.

14. The method of claim 13 wherein said location determining means is a GPS receiver.

15. The method of claim 13 wherein said wireless interface is a cellular telephone transceiver.

16. The method of claim 13 wherein said central database is located on a website.

17. The method of claim 16 wherein said wireless interface is a wireless internet access means.

18. The method of claim 17 wherein said remote data and position information is transferred via said wireless internet access means to said database located on said website by using the internet.

19. The method of claim 13 wherein said remote data is entered through a key entry means into a processor located at said remote site.

20. The method of claim 19 wherein said processor is a PDA.
